(19) United States
(12) Patent Application Publication
(10) Pub. No.: US 2012/0047895 A1
(43) Pub. Date: Mar. 1, 2012

(54) SYSTEMS AND APPARATUS RELATING TO COMBUSTOR COOLING AND OPERATION IN GAS TURBINE ENGINES

(75) Inventors: Kodukulla Venkat Sridhar, Bangalore (IN); Anand Prafulchandra Desai, Bangalore (IN)

(73) Assignee: General Electric Company

(21) Appl. No.: 12/868,793

(22) Filed: Aug. 26, 2010

(51) Int. Cl. F02C 1/00

(52) U.S. Cl. 60/722

(57) ABSTRACT

A combustor for a gas turbine engine that includes first and second combustion chambers interconnected by a throat region that includes a converging wall section, a diverging wall section, and a throat apex between the diverging wall section and the converging wall section; a plurality of cooling apertures disposed on the converging wall section; and a cooling slot disposed on the diverging wall section; wherein: the cooling apertures comprise apertures through the thickness of the converging wall section; and the cooling slot comprising a circumferentially extending slot through the length of the diverging wall section.

### BACKGROUND OF THE INVENTION

This present application relates generally to systems and/or apparatus for improving the efficiency and/or operation of turbine engines and/or industrial machinery, which, as used herein and unless specifically stated otherwise, is meant to include all types of combustion turbine or rotary engines, including gas turbine engines, aircraft engines, and others. More specifically, but not by way of limitation, the present application relates to methods, systems, and/or apparatus pertaining to combustor cooling and operation in gas turbine engines.

During operation of a gas turbine engine, combustion of fuel and compressed air mixture occurs inside a combustor. To prevent damage to the turbine or other parts of the gas turbine engine, the combustion process is stabilized to contain the process inside the combustor. Typically, a venturi is provided inside a combustion chamber of the combustor. A venturi substantially stabilizes the combustion process and prevents the flame from flashing backwards into other parts of the turbine engine. Further, various components of the combustor, especially walls of the combustion chamber and the venturi, require cooling to prevent damage and also, to increase the life of the components.

Over the years, different methods and systems have been used to provide cooling to various components of the combustor. This may include a liner, which circumferentially surrounds the combustion chamber and accepts a flow of a coolant. The coolant flowing through the liner may only provide surface cooling to the combustion chamber and the venturi. However, surface cooling may not be effective in cooling the combustion chamber and the venturi, which results in a reduced life for the combustor. Further, the coolant flowing through the liner may substantially include compressed air diverted from a compressor of the gas turbine engine. The compressed air, after performing the cooling operation, is discarded in an aft portion of the liner, which may reduce an efficiency of the gas turbine engine. Moreover, the venturi used in this type of cooling configuration may include more number of components and thus, involves a complicated construction.

Further, to reduce wastage of compressed air from the compressor, the compressed air may be introduced inside the combustion chamber, after performing cooling. However, such a configuration may further complicate the construction of the venturi and/or the combustion chamber and only provide a surface cooling of the parts of the combustor.

As a result, there is a need for improved systems and apparatus relating to the more efficient and cost effective cooling of the combustors in a gas turbine engines.

### BRIEF DESCRIPTION OF THE INVENTION

The present application, thus, describes a venturi for use in a combustor of a gas turbine engine, the venturi comprising two non-integrally formed pieces: a forward piece and an aft piece; wherein: the forward piece comprises a forward axial extension, a converging wall section, and a diverging outer-wall section; the aft piece comprises an aft axial extension and a diverging inner-wall section; and the forward piece and the aft piece are configured such that the diverging inner-wall section resides in close, spaced relation to the diverging outer-wall section such that a circumferentially extending cooling slot is formed therebetween.

The present application further describes a combustor for a gas turbine engine that includes first and second combustion chambers interconnected by a throat region that includes a converging wall section, a diverging wall section, and a throat apex between the diverging wall section and the converging wall section; a plurality of cooling apertures disposed on the converging wall section; and a cooling slot disposed on the diverging wall section; wherein: the cooling apertures comprise apertures through the thickness of the converging wall section; and the cooling slot comprising a circumferentially extending slot through the length of the diverging wall section.

These and other features of the present application will become apparent upon review of the following detailed description of the preferred embodiments when taken in conjunction with the drawings and the appended claims.

### BRIEF DESCRIPTION OF THE DRAWINGS

These and other features of this invention will be more completely understood and appreciated by careful study of the following more detailed description of exemplary embodiments of the invention taken in conjunction with the accompanying drawings, in which:

FIG. 1 is a partial cross-sectional view of a conventional combustor;

FIG. 2 is a partial cross-sectional view of a combustor, according to an exemplary embodiment of the present application;

FIG. 3 is a cross-sectional view of a venturi with at least two non-integrally formed pieces, according to an exemplary embodiment of the present application;

FIG. 4 is a cross-sectional view of the venturi with one or more turbulators on a diverging inner-wall section, according to an exemplary embodiment of the present application;

FIG. 5 is a cross-sectional view of the venturi with cooling apertures on the diverging inner-wall section, according to an exemplary embodiment of the present application; and

FIG. 6 is a cross-sectional view of the venturi with an integral construction, according to an exemplary embodiment of the present application.

### DETAILED DESCRIPTION OF THE INVENTION

As an initial matter, to communicate clearly the invention of the current application, it may be necessary to select terminology that refers to and describes certain parts or machine components of a combustion turbine engine. Whenever possible, common industry terminology will be used and employed in a manner consistent with its accepted meaning. However, it is meant that any such terminology be given a broad meaning and not narrowly construed such that the meaning intended herein and the scope of the appended claims is unreasonably restricted. Those of ordinary skill in the art will appreciate that often a particular component may be referred to using several different terms. In addition, what may be described herein as a single part may include and be referenced in another context as consisting of several component parts, or, what may be described herein as including multiple component parts may be fashioned into and, in some cases, referred to as a single part. As such, in understanding the scope of the invention described herein, attention should not only be paid to the terminology and description provided, but also to the structure, configuration, function, and/or usage of the component, as provided herein.

In addition, several descriptive terms may be used regularly herein, and it may be helpful to define these terms. These terms and their definitions, as used herein, are as follows. As used herein, “downstream” and “upstream” are terms that indicate a direction relative to the flow of a working fluid through the turbine. As such, the term “downstream” refers to a direction that generally corresponds to the direction of the flow of the working fluid, and the term “upstream” generally refers to the direction that is opposite of the direction of flow of the working fluid. The terms “forward” and “aft”, without any further specificity, refer to directions, with “forward” referring to the forward or compressor end of the engine and “aft” referring to the aft or turbine end of the engine. The term “radial” refers to movement or position perpendicular to an axis. It is often required to describe parts that are at differing radial positions with regard to an axis. In this case, if a first component resides closer to the axis than a second component, it may be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis.

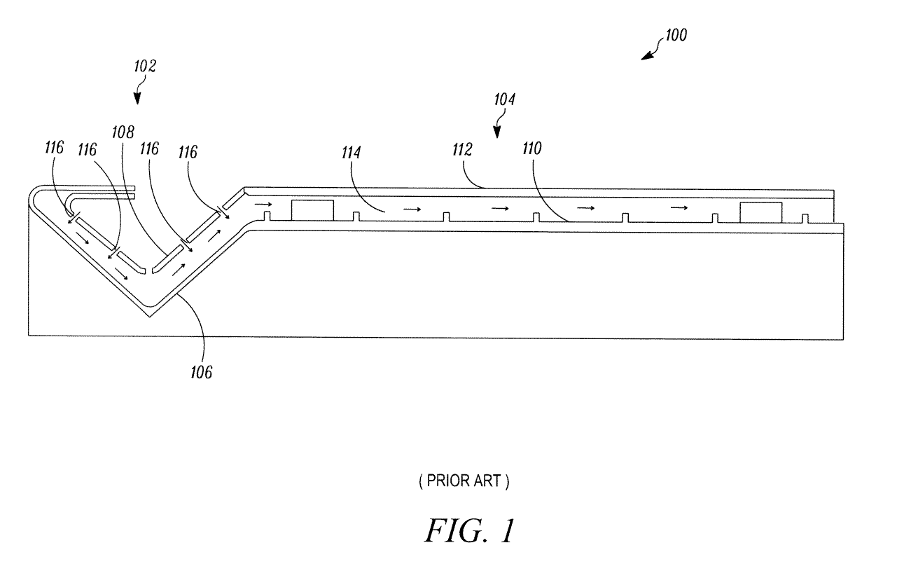

Referring now to the figures, where the various numbers represent like parts throughout the several views, FIG. 1 illustrates a partial cross-sectional view of a conventional combustor 100 of a gas turbine engine (not shown). The combustor 100 may include a venturi 102 and an axial portion 104. The venturi 102 may include an inner venturi portion 106 and an outer venturi portion 108. Also, the axial portion 104 of the combustor 100 may include an inner wall 110 and an outer wall 112. Further, a circumferential liner 114 may be formed between the inner and outer venturi portions 106 and 108, and the inner wall 110 and the outer wall 112. During a cooling process, a coolant may enter the liner 114 through multiple holes 116 that are provided in the outer venturi portion 108. The coolant may then flow through the liner 114 and substantially performs impingement cooling on the venturi 102. However, impingement cooling may only result in surface cooling, which may be ineffective at cool the venturi 102, and thus, the life of the component may be reduced. Moreover, improper cooling of the venturi 102 may also lead to an auto ignition of the fuel. Additionally, the coolant, after performing the cooling operation, may be discarded in an aft portion (not shown) of the liner 114, which may further reduce the efficiency of the gas turbine engine.

Further, the coolant may include coolant air that is diverted from combustor air, which is compressed in a compressor (not shown) and utilized for combustion. Thus, coolant air, which may form a significant part of combustor air, also reduces an efficiency of the gas turbine engine. Moreover, the venturi 102 may also include a large number of components and thus, involves a complicated construction because of the inner and outer venturi portions 106 and 108.

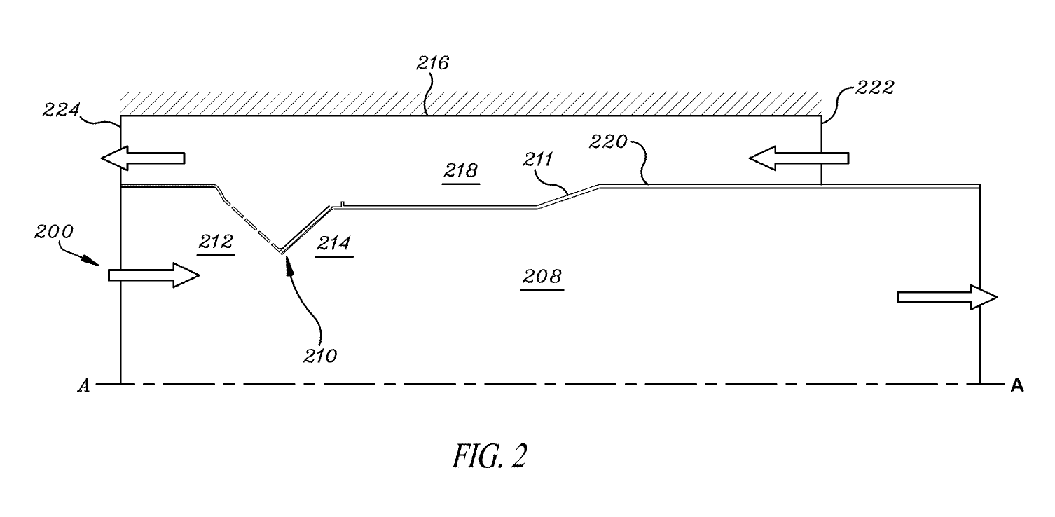

FIG. 2 illustrates a partial cross-sectional view of an exemplary combustor 200 of the gas turbine engine, according to an embodiment of the present application. Those of ordinary skill in the art will appreciate that the present application is not limited to this type of usage and may be used in other types of combustion turbine or rotary engines, such as, but not limited to, aircraft engines, power generation engines, steam turbine engines and the like. FIG. 2 illustrates an upper half of the combustor 200 for clarity. The combustor 200 may be substantially symmetric about a central axis A. Combustion of a combustor air and fuel mixture may occur inside the combustor 200. Subsequent to compression in the compressor, combustor air may be introduced at a head end (not shown) of the combustor 200 and fuel may be introduced in the combustor air to form the combustor air and fuel mixture.

The combustor 200 may include an inlet (not shown) for the entry of the combustor air and fuel mixture into a combustion chamber 208. In various embodiments of the present application, the combustor 200 may include one or more inlets. One or more ignition means (E.g. spark plugs) may be provided in the combustion chamber 208 to ignite the combustor air and fuel mixture. Subsequent to ignition, combustion products may exit the combustor 200 to a turbine (not shown). A venturi 210 may be provided inside the combustion chamber 208 to substantially stabilize in order to contain the ignition of the combustor air and fuel mixture inside the combustor 200. In an embodiment of the present application, a divergence step 211 may be provided downstream of the venturi 210 to substantially mitigate a screech of the combustor air and fuel mixture. As shown, the venturi 210 may substantially divide the combustion chamber into a first stage combustion chamber 212 and a second stage combustion chamber 214.

Further, a flow sleeve 216 may be provided to form a coolant plenum 218 between the flow sleeve 216 and a combustion chamber wall 220. The coolant plenum 218 may be disposed circumferentially around the combustor chamber 208. In an embodiment of the present application, the coolant plenum 218 may be configured to receive a flow of pressurized coolant through a flow sleeve inlet 222. In an embodiment of the present application, the pressurized coolant may be pressurized air diverted from the compressor. In another embodiment of the present application, the pressurized coolant may be pressurized air mixed with water, steam or inert gas. The pressurized coolant may flow through the coolant plenum 218 and exit the coolant plenum 218 through a flow sleeve outlet 224. Those of ordinary skill in the art will appreciate that the pressurized coolant may also flow in a direction opposite to the direction illustrated in FIG. 2 without deviating from the scope of the present application.

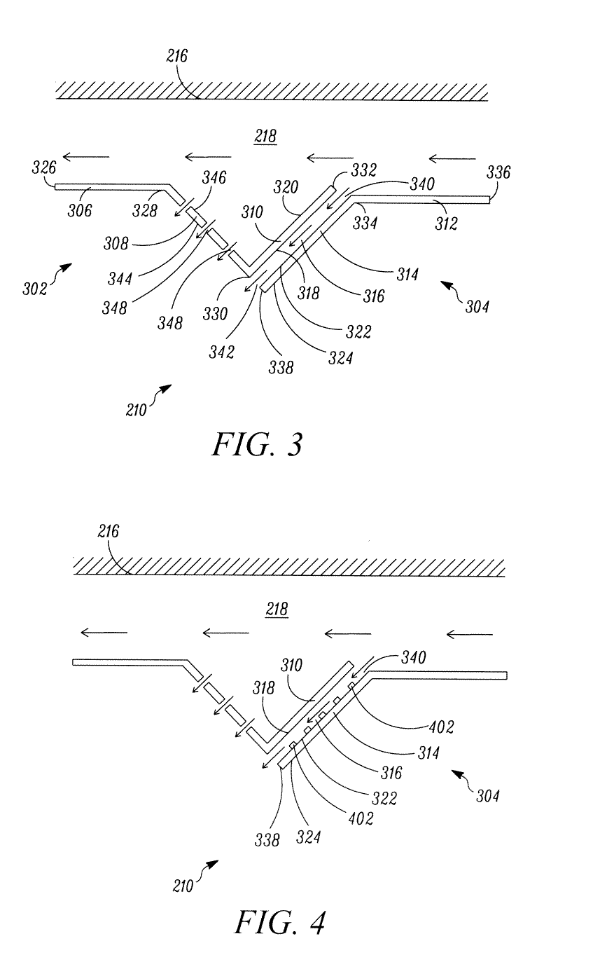

FIG. 3 illustrates a more detailed, non-scaled cross-sectional view of the venturi 210, in which coolant channels according to an exemplary embodiment of the present application are more clearly shown. In an embodiment of the present application, the venturi 210 may include a forward piece 302 and an aft piece 304. As illustrated in FIG. 2, the forward piece 302 and the aft piece 304 may be non-integrally formed. However, the venturi 210 may include more than two non-integrally formed pieces. In an embodiment of the present application, the forward piece 302 may include a forward axial extension 306, a converging wall section 308, and a diverging outer-wall section 310, while the aft piece 304 may include an aft axial extension 312 and a diverging inner-wall section 314. In an embodiment of the present application, the forward piece 302 and the aft piece 304 may be configured such that the diverging inner-wall section 314 reside in close, spaced relation with respect to the diverging outer-wall section 310. This may form a circumferentially extending cooling slot 316 (hereinafter referred to as “the cooling slot 316”) between the diverging outer-wall section 310 and the diverging inner-wall section 314. In an alternative embodiment of the present application (not shown), the forward piece 302 and the aft piece 304 may be configured such that the forward piece 302 includes the diverging inner-wall section 314 and the aft piece 304 includes the diverging outer-wall section 310.

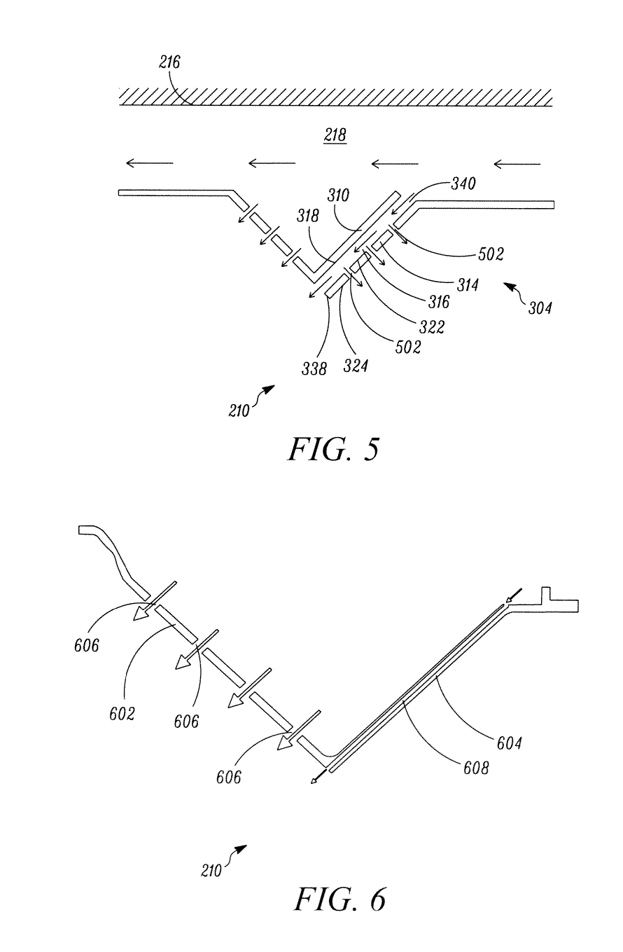

As illustrated in FIG. 3, the pressurized coolant flowing through the coolant plenum 218 may enter the combustion chamber 208 via the cooling slot 316. This may result in a substantially volumetric cooling of the venturi 210. Volumetric cooling may provide an improved cooling of the venturi 210 and prolong the life of the venturi 210. Further, volumetric cooling may also substantially prevent auto ignition of fuel inside the first stage combustion chamber 212. In various embodiments of the present application, the cooling slot 316 may also include turbulators and/or cooling apertures (described in conjunction with FIGS. 4 and 5 respectively) to enhance the cooling of the venturi 210. Further, the pressurized coolant, which enters the combustion chamber 208 and substantially includes pressurized air from the compressor, is utilized for combustion. This may substantially reduce wastage of pressurized air flowing through the coolant plenum 218 and also increases an efficiency of the gas turbine engine. Further, an amount of pressurized air, which is left after cooling, may be utilized for other purposes, such as, but not limited to, reducing pollutants like NOx, CO, and the like. In various embodiments of the present application, reduction in pollutants may be achieved by introducing the pressurized air, left after cooling, at the head-end of the combustor 200. In addition, the venturi 210 of the present application may require a lower number of components and, as such, present a simplified one or two-piece construction.

As illustrated in FIG. 3, the diverging outer-wall section 310 may include an inner face 318 that faces the cooling slot 316 and an outer face 320 that faces the coolant plenum 218. Further, the diverging inner-wall section 314 may include an outer face 322 that faces the cooling slot 316 and an inner face 324 that faces the second stage combustion chamber 214. Thus, the inner face 318 of the diverging outer-wall section 310 may oppose the outer face 322 of the diverging inner-wall section 314 across the cooling slot 316. In an embodiment of the present application, the forward piece 302 may be configured such that the forward axial extension 306 extends axially along an approximate outer radial position of the combustor 200 from a forward end 326 to an aft end 328. The approximate outer radial position of the combustor 200 may correspond substantially to a radial position of the combustion chamber wall 220. Further, the converging wall section 308 may extend diagonally inward substantially from the aft end 328 of the forward axial extension 306 to a throat apex 330. A radial position of the throat apex 330 may correspond to a constriction of the venturi 210, which accelerates the flow of the combustor air and fuel mixture. Additionally, the diverging outer-wall section 310 may extend diagonally outward substantially from the throat apex 330 to an end 332 corresponding to the approximate radial outer position of the combustor 200. In an embodiment of the present application, the aft piece 304 is configured such that the aft axial extension 312 may extend axially along the approximate outer radial position of the combustor 200 from a forward end 334 to an aft end 336. Further, the diverging inner-wall section 314 may extend diagonally inward substantially from the forward end 334 of the aft axial extension 312 to an end 338. The end 338 may be located at a position which is proximate to the throat apex 330.

In an embodiment of the present application, the cooling slot 316 may include a mouth 340, which is defined between the end 332 of the outer-wall section 310 and a section of the aft piece 304 where the aft axial extension 312 transitions to the diverging inner-wall section 314. Such a section of the aft piece 304 may be proximate to the forward end 334 of the aft axial extension 312. In an embodiment of the present application, the cooling slot 316 may include an outlet 342 defined between the end 338 of the diverging inner-wall section 314 of the aft piece 304 and the throat apex 330 of the forward piece 302. In various embodiments of the present application, at least one of the sections of the forward piece 302 or the aft piece 304 where the forward axial extension 306 or the aft axial extension 312 transitions to the converging wall section 308 or the diverging inner wall section 314 may be chamfered or filleted.

As illustrated in FIG. 3, the converging wall section 308 may include an inner face 344 that faces the first stage combustion chamber 212 and an outer face 346 that faces the coolant plenum 218. In an embodiment of the present application, the converging wall section 308 may include multiple cooling apertures 348. As illustrated in FIG. 3, each of the cooling apertures 348 may originate on the outer face 346 and extend through the thickness of the converging wall section 308 to an opening on the inner face 344. Thus, the cooling apertures 348 may provide additional passageways for the pressurized coolant from the coolant plenum 218 to the combustion chamber 208. Thus, the cooling apertures 348 may further enhance cooling of the forward piece 302 of the venturi 210. In an embodiment of the present application, at least one of the cooling apertures 348 may be of a substantially cylindrical shape. However, other shapes of the cooling apertures 348 may be possible without departing from the scope of the present application.

In an embodiment of the present application, the cooling apertures 348 may be configured such that each of the cooling apertures 348 is approximately perpendicular to the inner face 344 and the outer face 346 of the converging wall section 308. In an alternative embodiment of the present application, the cooling apertures 348 may be obliquely oriented with respect to the inner face 344 and the outer face 346 of the converging wall section 308. In an embodiment of the present application, the cooling apertures 348 on the converging wall section 308 may be arranged in multiple circumferentially extending rows. However, the cooling apertures 348 on the converging wall section 308 may be arranged in any other configuration (E.g. staggered) without deviating from the scope of the present application.

In an embodiment of the present application, the cooling apertures 348 may be configured such that each of the cooling apertures 348 is approximately perpendicular to the inner face 344 and the outer face 346 of the converging wall section 308. In an alternative embodiment of the present application, the cooling apertures 348 may be tilted with respect to the centerline A-A shown in FIG. 2. It will be appreciated that this will produce a performance-enhancing swirl about the centerline in the pressurized coolant flowing through apertures 348.

FIG. 4 illustrates a detailed cross-sectional view of the exemplary venturi 210, according to an embodiment of the present application. As illustrated in FIG. 4, the outer face 322 of the diverging inner-wall section 314 may include one or more turbulators 402. Those of ordinary skill in the art will appreciate that the turbulators 402 may be provided on the inner face 318 of the diverging outer-wall section 310 without departing from the scope of the present application. Turbulators 402 on the outer face 322 of the diverging inner-wall section 314 may cause turbulence in the pressurized coolant flowing through the cooling slot 316, and thus, enhances cooling of the aft piece 304 of the venturi 210. As illustrated in FIG. 4, the turbulators 402 may have a substantially rectangular cross-section. However, the turbulators 402 may have any other cross-section, such as, but not limited to, circular, elliptical, polygonal, or the like.

FIG. 5 illustrates a detailed cross-sectional view of the exemplary venturi 210, according to another embodiment of the present application. As illustrated in FIG. 5, the diverging inner-wall section 314 may include multiple cooling apertures 502. Each of the cooling apertures 502 may originate on the outer face 322 and extend through the thickness of the diverging inner-wall section 314 to an opening on the inner face 324, and thus, creates a passageway for the pressurized coolant through the diverging inner-wall section 314. Thus, the cooling apertures 502 may further enhance cooling of the aft piece 304 of the venturi 210. In an embodiment of the present application, at least one of the cooling apertures 502 may be of a substantially cylindrical shape. Those of ordinary skill in the art will appreciate that other shapes of the cooling apertures 502 may be possible without departing from the scope of the present application.

In an embodiment of the present application, the cooling apertures 502 may be configured such that each of the cooling apertures 502 is approximately perpendicular to the inner face 324 and the outer face 322 of the diverging inner-wall section 314. In an alternative embodiment of the present application, the cooling apertures 502 may be tilted with respect to the centerline A-A shown in FIG. 2. It will be appreciated that this will produce a performance-enhancing swirl about the centerline to the pressurized coolant flowing through apertures 502.

In an embodiment of the present application, the cooling apertures 502 may be configured such that each of the cooling apertures 502 is approximately perpendicular to the inner face 324 and the outer face 322 of the diverging inner-wall section 314. In an alternative embodiment of the present application, the cooling apertures 502 may be obliquely oriented with respect to the inner face 324 and the outer face 322 of the diverging inner-wall section 314. In an embodiment of the present application, the cooling apertures 502 on the diverging inner-wall section 314 may be arranged in multiple circumferentially extending rows. However, the cooling apertures 502 on the diverging inner-wall section 314 may be arranged in any other configuration (E.g. staggered) without deviating from the scope of the present application.

FIG. 6 illustrates a detailed cross-sectional view of the exemplary venturi 210, according to another exemplary embodiment of the present application. As illustrated in FIG. 6, the venturi 210 may be of an integral construction with a forward portion 602 and an aft portion 604. Further, the forward portion 602 may include multiple cooling apertures 606. In an embodiment of the present application, the aft portion 604 may include multiple through holes 608. Particularly, only one through hole 608 is visible in FIG. 6, other through holes 608 may be arranged circumferentially in the aft portion 604. The pressurized coolant may flow though the cooling apertures 606 and the through hole 608 to result in a volumetric cooling of the venturi 210.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, all of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A venturi for use in a combustor of a gas turbine engine, the venturi comprising two non-integrally formed pieces: a forward piece and an aft piece;
wherein:
the forward piece comprises a forward axial extension, a converging wall section, and a diverging outer-wall section;
the aft piece comprises an aft axial extension and a diverging inner-wall section; and
the forward piece and the aft piece are configured such that the diverging inner-wall section resides in close, spaced relation to the diverging outer-wall section such that a circumferentially extending cooling slot is formed therebetween.

2. The venturi according to claim 1, wherein the converging wall section comprises an inner face that faces a first stage combustion chamber of the combustor and an outer face that faces a coolant plenum, the coolant plenum being disposed along the exterior of the combustor.

3. The venturi according to claim 2, wherein the converging wall section comprises a plurality of cooling apertures.

4. The venturi according to claim 3, wherein the cooling apertures comprise apertures that originate on the outer face and extend through the thickness of the converging wall section to an opening on the inner face, thereby creating a passageway through the converging wall section.

5. The venturi according to claim 4, wherein the cooling apertures comprise a cylindrical shape.

6. The venturi according to claim 4, wherein the cooling apertures are configured such that each is substantially perpendicular to the outer and inner faces of the converging wall section.

7. The venturi according to claim 4, wherein the cooling apertures are tilted in relation to a combustor centerline such that, in operation, a swirl about the combustor centerline is produced in the coolant passing therethrough.

8. The venturi according to claim 3, wherein the diverging outer-wall section comprises an inner face that faces the cooling slot and an outer face that faces the coolant plenum;
wherein the diverging inner-wall section comprises an outer face that faces the cooling slot and an inner face that faces a second stage combustion chamber of the combustor.

9. The venturi according to claim 8, wherein the coolant plenum is configured to receive a flow of pressurized coolant.

10. The venturi according to claim 8, wherein the outer face of the diverging inner-wall section opposes the inner face of the diverging outer-wall section across the cooling slot.

11. The venturi according to claim 8, wherein the forward piece is configured such that:
the forward axial extension extends axially along an approximate outer radial position of the combustor;
the converging wall-section extends diagonally inward from an aft end of the forward axial extension to a throat apex; and
the diverging outer-wall section extends diagonally outward from the throat apex to the approximate outer radial position of the combustor where the forward piece ends.

12. The venturi according to claim 11, wherein the aft piece is configured such that:
the aft axial extension extends axially along the approximate outer radial position of the combustor; and
the diverging inner-wall section extends diagonally inward from a forward end of the aft axial extension to a position in proximity to the throat apex where the aft piece ends.

13. The venturi according to claim 12, wherein the cooling slot comprises a mouth that is defined between: a) the end of the diverging outer-wall section of the forward piece; and b) a section of the aft piece where the aft axial extension transitions to the diverging inner-wall section.

14. The venturi according to claim 13, wherein the cooling slot comprises an outlet that is defined between: a) the end of the diverging inner-wall section of the aft piece; and b) the throat apex of the forward piece.

15. The venturi according to claim 8, wherein the outer face of the diverging inner-wall section comprises turbulators.

16. The venturi according to claim 8, wherein the diverging inner-wall section comprises a plurality of cooling apertures, wherein the cooling apertures comprise apertures that originate on the outer face and extend through the thickness of the diverging inner-wall section to an opening on the inner face, thereby creating a passageway through the diverging inner-wall section.

17. The venturi according to claim 16, wherein the cooling apertures on the diverging inner-wall section are tilted in relation to a combustor centerline such that, in operation, a swirl about the combustor centerline is produced in the coolant passing therethrough.

18. A combustor for a gas turbine engine comprising:
first and second combustion chambers interconnected by a throat region that includes a converging wall section, a diverging wall section, and a throat apex between the diverging wall section and the converging wall section;
a plurality of cooling apertures disposed on the converging wall section; and
a cooling slot disposed on the diverging wall section;
wherein:
the cooling apertures comprise apertures through the thickness of the converging wall section; and
the cooling slot comprising a circumferentially extending slot through the length of the diverging wall section.

19. The combustor according to claim 18, further comprising a coolant plenum formed along the exterior of the venturi;
wherein:
the cooling slot comprises a mouth at the coolant plenum; and
the cooling slot comprises an outlet at the throat apex.

20. The combustor according to claim 18, wherein the cooling slot includes a plurality of cooling apertures formed therein, wherein the cooling apertures are formed substantially perpendicular to the cooling slot and comprise passageways that originate at the cooling slot and extend through an inner face of the diverging wall to the second combustion chamber.
